(19) United States
(12) Patent Application Publication
(10) Pub. No.: US 2019/0385206 A1
(43) Pub. Date: Dec. 19, 2019

(54) FITTING ROOM VIRTUAL ASSISTANT BASED ON REAL-TIME INTERNET OF THINGS (IOT) SENSORS

(71) Applicant: INTERNATIONAL BUSINESS MACHINES CORPORATION, Armonk, NY (US)

(72) Inventor: Lisa Seacat DeLuca, Baltimore, MD (US)

(21) Appl. No.: 16/008,630

(22) Filed: Jun. 14, 2018

(51) Int. Cl. G06Q 30/06; G10L 15/22; G10L 15/30

(52) U.S. Cl. CPC G06Q 30/0617; G10L 15/22; H04L 67/12; G10L 2015/223; G10L 15/30

(57) ABSTRACT

Embodiments of the present invention disclose a method, computer program product, and system for a fitting room virtual assistant based on IoT sensors. The computer may receive a plurality of merchandise tracking data. The plurality of merchandise tracking data may show a location of a plurality of merchandise in a fitting room. A question may be received from a customer. The customer may ask a virtual assistant the question. It may be determined whether a sales associate should be contacted based on the nature of the question. An action may be performed based on the determination.

### BACKGROUND

The present invention relates generally to the field of computing, and more particularly to virtual assistants.

A virtual assistant is usually a cloud based program that works through internet connected devices or applications. The virtual assistant understands natural language voice commands and is capable of responding to the user. The virtual assistant is also capable of completing some tasks for the user. The technology of virtual assistants require data for machine learning, natural language processing, and speech recognition.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for a fitting room virtual assistant based on IoT sensors. The computer may receive a plurality of merchandise tracking data. The plurality of merchandise tracking data may show a location of a plurality of merchandise in a fitting room. A question may be received from a customer. The customer may ask a virtual assistant the question. It may be determined whether a sales associate should be contacted based on the nature of the question. An action may be performed based on the determination.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a functional block diagram illustrating a system for a real-time fitting room virtual assistant, in accordance with an embodiment of the present invention.

FIGS. 2A and 2B are flowcharts depicting operational steps of the real-time fitting room virtual assistant of FIG. 1, in accordance with an embodiment of the present invention.

FIG. 3 illustrates an example of a retail store, where the present invention can be implemented.

FIG. 4 illustrates an example of a sales associate mobile device, where the present invention can be implemented.

FIG. 5 is a block diagram of components of a computing device of the system for the real-time fitting room virtual of FIG. 1, in accordance with embodiments of the present invention.

FIG. 6 depicts a cloud computing environment according to an embodiment of the present invention.

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to virtual assistants. The following described exemplary embodiments provide a system, method, and program for, among other things, a virtual assistant based on the IoT to help customers in a fitting room. Therefore, the present embodiment has the capacity to better engage customers with their retail shopping experience.

As previously described, a virtual assistant is usually a cloud based program that works through internet connected devices or applications. The virtual assistant understands natural language voice commands and is capable of responding to the user. The virtual assistant is also capable of completing some tasks for the user. The technology of virtual assistants require data for machine learning, natural language processing, and speech recognition.

Often, when a customer goes into a retail store and takes items to the fitting room, a store associate is standing nearby to help the customer in case of the need for an additional size or color. However, it can be awkward for a customer to interact with these people and sometimes, especially during the holiday season, there are more customers in the fitting room area than one sales associate can assist. This leaves customers feeling disengaged when they are ignored over other customers.

When a customer is shopping in a retail store and brings items to the fitting room, there is usually a sales associate near the fitting room area to assist customers. The sales associate is there to help find additional sizes and colors for items. Some people find it awkward to interact with the sales associates due to privacy concerns surrounding the fitting room experience. While others find it inconvenient, especially during the holiday season when there can be more customers in the fitting room than one sales associate can handle. Such situations can anger customers when a sales associate ignores one customer over another along with taking more time in the fitting room than is necessary. As such, it may be advantageous to, among other things, implement a system capable of being unbiased and being based on real-time IoT in order to best help customers.

According to one embodiment, a virtual assistant may answer any questions that a customer has and is capable of contacting a sales associate for help. The system for the real-time fitting room virtual assistant may allow customers to better engage with their retail shopping experience. A physical retail store may equip each fitting room with a virtual assistant device. The virtual assistant may be Watson Assistant® (Watson and all Watson-related trademarks and logos are trademarks or registered trademarks of Watson and/or its affiliates), Amazon Echo/Alexa® (Amazon and all Amazon-related trademarks and logos are trademarks or registered trademarks of Amazon and/or its affiliates), Google Home® (Google and all Google-related trademarks and logos are trademarks or registered trademarks of Google and/or its affiliates), and other such virtual assistants. All of the merchandise in the store may be tagged using existing technologies, such as radio-frequency identification (RFID) tags, accelerometers, Bluetooth, and other tagging technologies. As soon as a customer walks into the fitting room, the virtual assistant may provide an introduction on how to use the technology while the merchandise brought into the fitting room by the user is detected.

During a customer's usage of a fitting room, the virtual assistant may be capable of receiving and understanding whether the customer asked a question using known voice recognition technology. Upon determining a question was asked, the system may evaluate the nature of the question to determine whether a response can be immediately provided or whether a sales associate's assistance is needed. When a sales associate does not need to be contacted, the system may provide an answer to the question through available repository data, such as inventory information. When sales associate assistance is needed, a sales associate may be located and contacted on a mobile device. Upon contacting a sales associate or obtaining a response through available repository data, the customer can be provided the response or attention from a sales associate as needed.

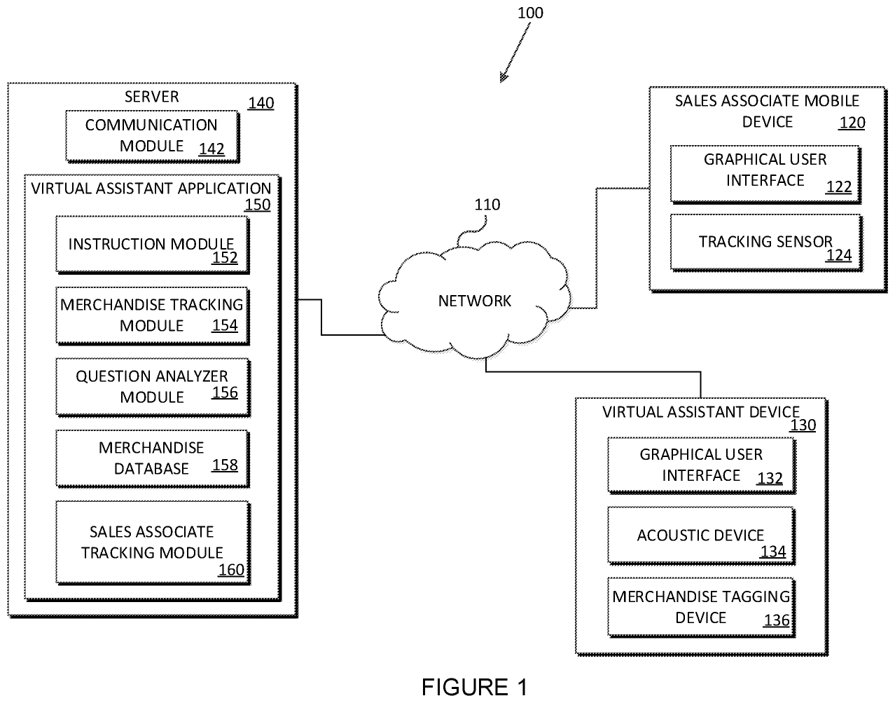

FIG. 1 is a functional block diagram illustrating a system for a fitting room virtual assistant based on real-time IoT 100, in accordance with an embodiment of the present invention.

The system for a fitting room virtual assistant based on real-time IoT 100 may include a sales associate mobile device 120, a virtual assistant device 130, and a server 140. The sales associate mobile device 120, the virtual assistant device 130, and the server 140 are able to communicate with each other via a network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between the sales associate mobile device 120, the virtual assistant device 130, and the server 140, in accordance with one or more embodiments of the invention.

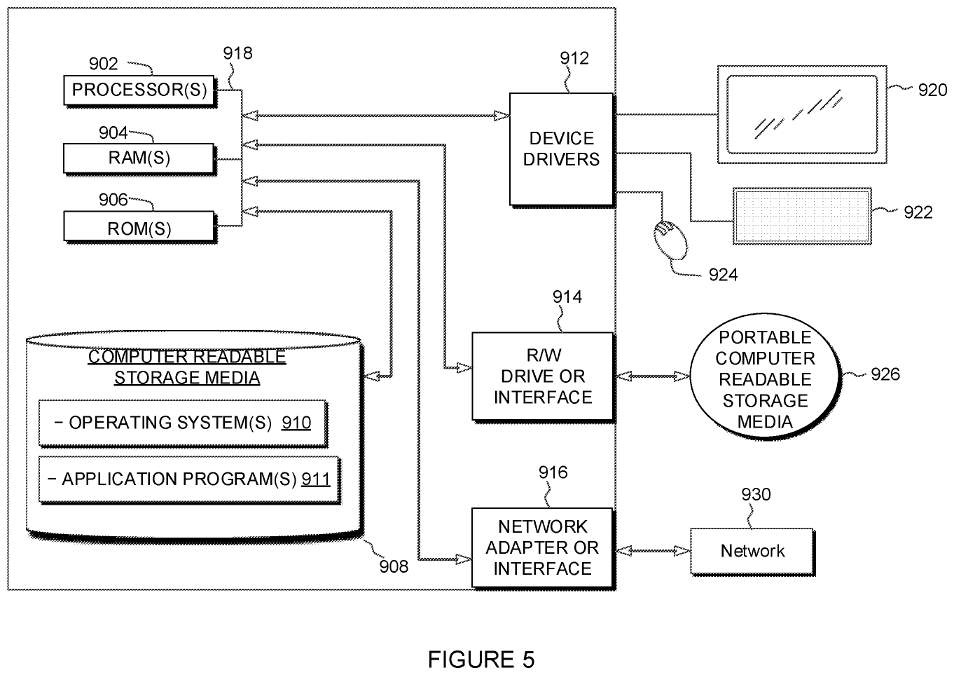

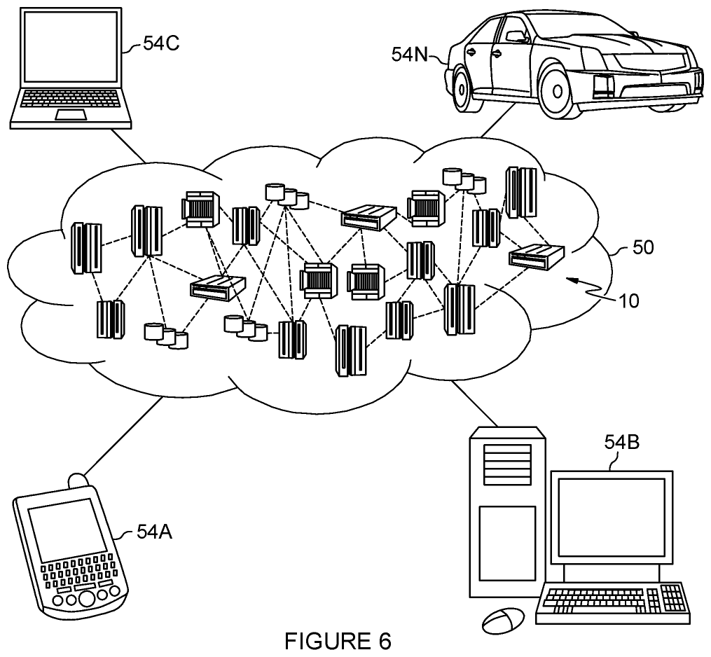

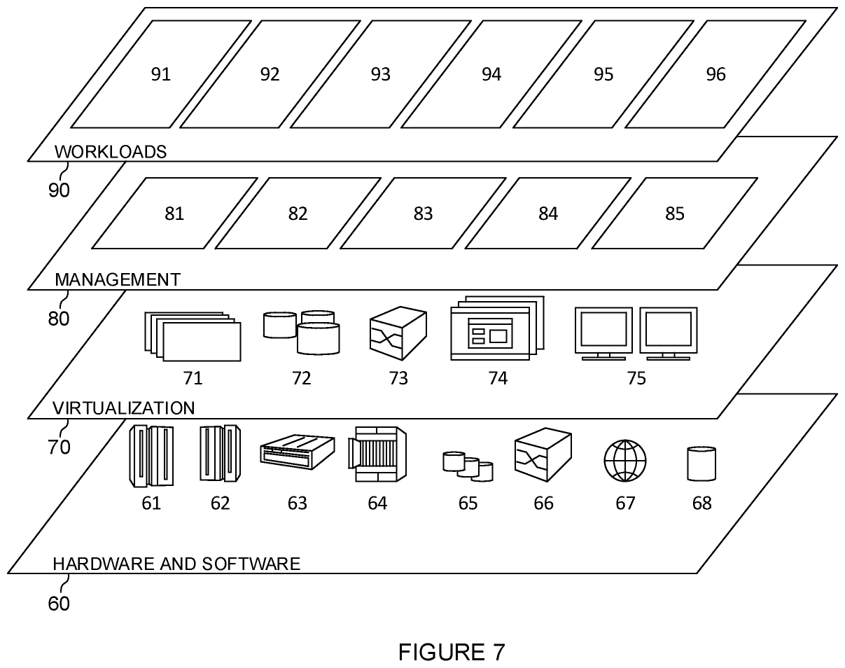

The sales associate mobile device and the virtual assistant device 130 may be any type of computing device that is capable of connecting to network 110, for example, a laptop computer, tablet computer, netbook computer, personal computer (PC), a desktop computer, a smart phone, or any programmable electronic device supporting the functionality required by one or more embodiments of the invention. The virtual assistant device 130 may include internal and external hardware components, as described in further detail below with respect to FIG. 5. In other embodiments, the server 140 may operate in a cloud computing environment, as described in further detail below with respect to FIGS. 6 and 7.

The sales associate mobile device 120 represents a computing device that may include a user interface, for example, a graphical user interface 122. The graphical user interface 122 can be any type of application that contains an interface to receive a request from a sales associate tracking module 160 and an interface to update the status of a request from the sales associate tracking module 160, for example, the application can be a web application or any type of application/program that allows a sales associate to view and update a request. The sales associate mobile device 120 may further include a tracking sensor 124. The tracking sensor 124 can use a global positioning system, WIFI tracking, cameras, or other means to track sales associates in a retail store. The tracking sensor 124 may transmit its data to the sales associate tracking module 160.

The virtual assistant device 130 may be a computing device that includes a user interface, for example, a graphical user interface 132. The graphical user interface 134 can be any type of application that contains the interface to receive information from an instruction module 152 and a merchandise database 158, for example, the application can be a web application or any other type of application that allows a customer to view the information. Further, the virtual assistant device may include an acoustic device 134 that is able to play auditory instructions from the instruction module 152 and auditory merchandise information from the merchandise database 158. The acoustic device 134 may also receive verbal commands, requests, or other statements from the customer. Additionally, the virtual assistant device 130 may include a merchandise tagging device 136. The merchandise tagging device 136 can use RFID tags, accelerometers, Bluetooth, and other tagging technologies. The merchandise tagging device 136 transmits merchandise information to the merchandise tracking module 154.

The server 140 includes a communication module 142 and a virtual assistant application 150. The server 140 is able to communicate with the sales associate mobile device 120 and the virtual assistant device 130, via network 110. The server 140 may include internal and external hardware components, as depicted and described in further detail below with reference to FIG. 5. In other embodiments, the server 140 may operate in a cloud computing environment, as depicted in FIG. 6 and FIG. 7.

The communication module 142 is capable of communicating between the sales associate mobile device 120, the virtual assistant device 130, and the virtual assistant application 150. The communication module 142 may transmit instructions from the instruction module 152 and merchandise information from the merchandise database 158 to the virtual assistant device 130 and it may transmit requests from the sales associate tracking module 160 to the sales associate mobile device 120. The communication module 142 may receive commands from the virtual assistant device 130 and updates from the sales associate mobile device 120. Furthermore, the communication module 142 may transmit the commands from the virtual assistant device 130 to a question analyzer module 156 and the updates from the sales associate mobile device 120 to the sales associate tracking module 160.

The virtual assistant application 150 may include the instruction module 152, a merchandise tracking module 154, the question analyzer module 156, the merchandise database 158, and the sales associate tracking module 160.

The instruction module 152 may transmit instructions on how to use the system to the virtual assistance device 130, via the communication module 142. The instructions can be displayed on the graphical user interface 132 or played auditorily through the acoustic device 134. The instruction module 152 may contain instructions such as an introduction to the customer and directions on how to ask questions.

The merchandise tracking module 154 may contain the application to track the merchandise in the fitting room. The merchandise tracking module 154 may receive the merchandise information from the merchandise tagging device 136. The merchandise tracking module 154 can use RFID tags, accelerometers, Bluetooth, and other tagging technologies in order to track the merchandise being asked about or requested in the fitting room. Furthermore, the merchandise tracking module 154 may determine whether the customer is still in the fitting room based on the tracking of the merchandise.

The question analyzer module 156 may receive any commands or questions from the virtual assistant device 130, via the communication module 142. When a command or question is received, it may be analyzed by the question analyzer module 156 in order to determine how to proceed. When the command or question can be answered by stored information, the question analyzer module 156 may transmit the question to the merchandise database 158. When the stored information cannot answer the command or question, the question analyzer module 156 may transmit the command or question to the sales associate tracking module 160. The question analyzer module 156 may also have to ask the customer to clarify which article of merchandise is in question if it cannot be determined by the merchandise tracking module 154.

The merchandise database 158 may be a data store that may store information on all merchandise in the retail store. The information stored could be price, material, material care instructions, colors it comes in, other merchandise to be paired with it, and other such information. The merchandise databased 158 may transmit the requested information to the virtual assistant device 130.

The sales associate tracking module 160 may receive data from the tracking sensor 124 on the whereabouts of sales associates in the retail store. The sales associate tracking module 160 may contact the sales associate mobile device 120. Furthermore, the sales associate tracking module 160 may confirm the request and status with the sales associate, via the sales associate mobile device 120.

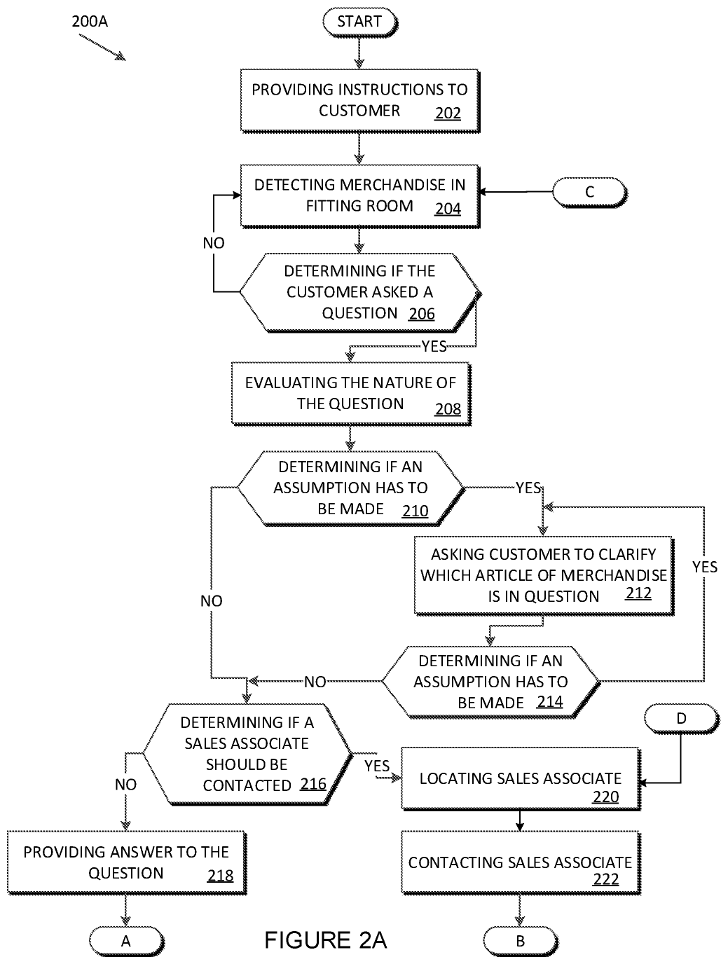

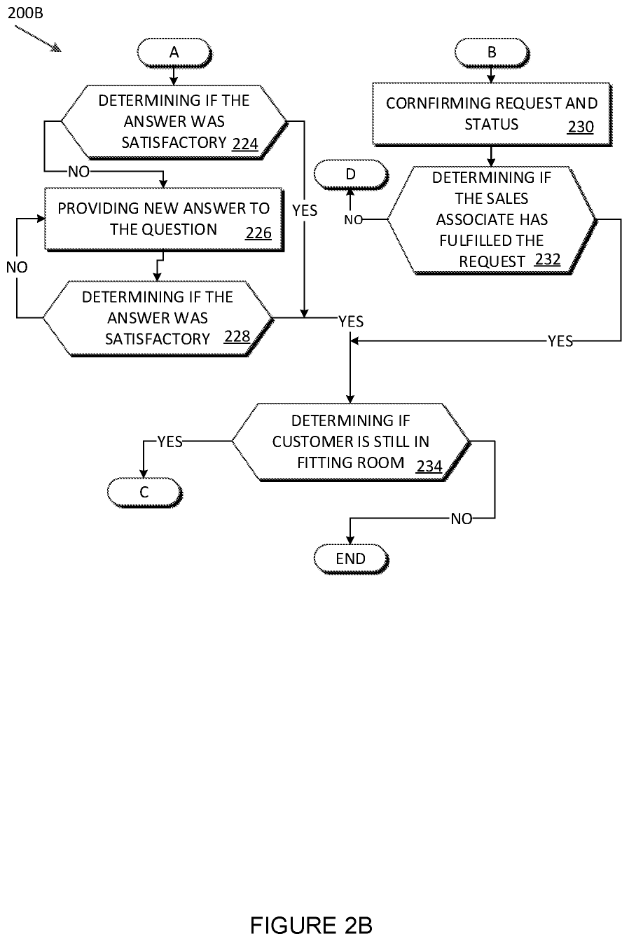

FIGS. 2A and 2B depict an operational flowchart 200 illustrating a fitting-room virtual assistant based on real-time IoT. In FIG. 2A, at 202, the instruction module 152 provides instructions to the customer. The instruction module 152 may transmit the instructions to the virtual assistant device 130, via the communication module 142. The instructions may be played auditorily through the acoustic device 134 or displayed through the graphical user interface 132. The instructions provided by the instruction module 152 may include an introduction and directions on how to use the virtual assistant device 130. For example, the virtual assistant device 130 may say “Hello, I'm Gina, a virtual assistant powered by IBM Watson® (Watson and all Watson-related trademarks and logos are trademarks or registered trademarks of Watson and/or its affiliates). If you have any questions about your merchandise or need any help such as different sizes or colors, just say ‘Hey Gina’, and ask.”

Then, at 204, the merchandise tracking module 154 detects the merchandise in the fitting room. The merchandise tracking module 154 may receive data about the merchandise in the fitting room from the merchandise tagging device 136. The merchandise tagging device 136 may use RFID tags, accelerometers, Bluetooth, or other tagging solutions to track when merchandise enters or exits the fitting room. For example, all of the merchandise in the retail store have RFID sensors on them so the merchandise tagging device can sense what is in the fitting room. In at least one embodiment, the merchandise tracking module 154 may be capable of identifying each piece of merchandise through optical recognition technology. For example, the merchandise tracking module 154 may capture an image of an item and compare the captured image to inventory data or may scan a bar code that is within view of an image capture device.

Next, at 206, the question analyzer module 156 determines whether the customer asked a question. The acoustic device 134 may detect commands and questions from the customer and transmit them to the question analyzer module 156, via the communication device 142. When it has been determined that the customer did not ask a question, the merchandise tracking module 154 may continue to detect merchandise in the fitting room (step 204). For example, if no words are picked up by the acoustic device 134, the merchandise tracking module 154 continues to detect the merchandise.

Then, at 208, when it has been determined that the customer asked a question, the question analyzer module 156 evaluates the nature of the question. The acoustic device 134 may detect a command or question from the customer and may transmit it to the question analyzer module 156, via the communication module 142. The question analyzer module 156 may determine whether the customer is asking about the price, the material, the size, the color, or something else related to the article of merchandise. For example, a customer may say, “Hey Gina, can you bring me these jeans in a smaller size?”. The question analyzer module 156 would recognize that this is asking about the size.

Next, at 210, the question analyzer module 156 determines whether an assumption has to be made. An assumption may have to be made when the question analyzer module 156 determines that the question is about a specific article of merchandise and the merchandise tracking module 154 may not know which specific article of merchandise the question is referring to. Otherwise, the merchandise tracking module 154 can determine which article of merchandise that the question is referring to. For example, when the customer asks for a smaller size in a pair of jeans but the customer has two different pairs of jeans in the fitting room, the merchandise tracking module 154 may not be able to determine which pair of jeans the customer is referring to.

Then, at 212, when it has been determined that an assumption has to be made, the question analyzer module 156 asks the customer to clarify which article of merchandise is in question. The question analyzer module 156 may transmit a message to the virtual assistant device 130 to ask the customer to clarify which article of merchandise is in question by scanning it using the merchandise tagging device 136. After the article of merchandise has been scanned, the merchandise tagging device 136 may transmit the information back to the merchandise tracking module 156. For example, the virtual assistant device 130 may ask the customer to scan which pair of jeans that the customer is asking about.

Next, at 214, the question analyzer module 156 determines whether an assumption has to be made. Again, an assumption may have to be made when the question analyzer module 156 determines that the question is about a specific article of merchandise and the merchandise tracking module 154 may not know which specific article of merchandise the question is referring to. Otherwise, the merchandise tracking module 154 may determine which article of merchandise that the question is referring to. When it is determined that an assumption has to be made, the question analyzer module 156 may ask the customer to clarify which article of merchandise is in question (step 212). For example, when the customer asks for a smaller size in a pair of jeans but the customer has five different pairs of jeans in the fitting room, the merchandise tracking module 154 may not be able to determine which pair of jeans the customer is referring to.

Then, at 216, when it has been determined that an assumption does not have to be made, the question analyzer module 156 determines whether a sales associate should be contacted. When the merchandise tracking module 154 knows which article of merchandise the customer is referring to and the question analyzer module 156 has evaluated the nature of the question, the question analyzer module 156 may determine whether a sales associate needs to be contacted. A sales associate may need to be contacted when the customer needs a new size or color, or a new article of merchandise to match an article of merchandise the customer already has in the fitting room. All other questions may be answered by the merchandise database 158. For example, the question analyzer module 156 may determine whether a sales associate needs to be contacted after a customer asks for a new size in an article of merchandise.

Next, at 218, when it has been determined that a sales associate does not need to be contacted, the merchandise database 158 provides an answer to the question. The merchandise database 158 may contain information on each article of merchandise in the retail store. The information stored could be price, material, material care instructions, available color options, other merchandise to be paired with it, and other such information. Based on the nature of the question determined by the question analyzer module 156 and on the specific article of merchandise determined by the merchandise tracking module 154, the merchandise database 158 may provide an answer to the question. The merchandise database 158 may transmit the answer to the virtual assistant device 130, via the communication module 142. For example, a customer asks, “What is this shirt made of?” and the merchandise database 158 may respond with “one hundred percent cotton”.

Then, at 220, when it has been determined that a sales associate does need to be contacted, the sales associate tracking module 160 locates the sales associate. The tracking sensor 124 may transmit sales associate locations to the sales associate tracking module 160. The tracking sensor 124 can use a global positioning system, WIFI tracking, cameras, or other means to track sales associates in a retail store. The sales associate tracking module 160 may look to find the sales associate that is closest to the article of merchandise in question. For example, when a customer is asking for a new size in a pair of jeans, the sales associate closest to the jeans display may be located by the sales associate tracking module 160.

Next, at 222, the sales associate tracking module 160 contacts the sales associate. The sales associate tracking module 160 may contact the sales associate located by transmitting a request to the sales associate mobile device 120. The request may include the article of merchandise to grab and which fitting room to bring it to. For example, a request may come across the sales associate mobile device 120 that says, “A customer in fitting room 2 would like high rise slim straight fit jeans in a size 6”.

Referring now to FIG. 2B, at 224, the question analyzer module 156 determines whether the answer to the question was satisfactory. The question analyzer module 156 may determine whether the answer is satisfactory by evaluating the command from the customer. When an answer is satisfactory, a customer may express a satisfactory command such as saying “thank you” or something of that nature. When an answer is not satisfactory, a customer may express a dissatisfied command such as saying “no, I mean this” or something of that nature. For example, if a customer asked about the care instructions for a shirt and the merchandise database 158 responded with washing instructions, the customer could respond and say “no, I mean can it be ironed?”. Based on the customers response, the customer was dissatisfied with the answer.

Next, at 226, when it has been determined that the answer was not satisfactory, the merchandise database 158 provides a new answer to the question. The merchandise database 158 may take into consideration the latest command from the customer and may provide new information to the customer for the article of merchandise they are referring to. For example, after the customer said, “no, I mean can it be ironed?”, the merchandise databased 158 would respond with the ironing instructions.

Then, at 228, the question analyzer module 156 determines whether the answer to the question was satisfactory. The question analyzer module 156 may determine whether the answer is satisfactory by evaluating the command from the customer. When an answer is satisfactory, a customer may express a satisfactory command such as saying “thank you” or something of that nature. When an answer is not satisfactory, a customer may express a dissatisfied command such as saying “no, I mean this” or something of that nature. When the customer is dissatisfied, the merchandise database 158 may continue to provide new answers to the question until the customer is satisfied (step 226). For example, a satisfied customer may say “thank you” after their question has been answered, indicating that they are satisfied.

Next, at 230, the sales associate tracking module 160 confirms the request and status. The sales associate may confirm the request and update the status of the request on the sales associate mobile device 120. The sales associate mobile device 120 may transit the sales associates' confirmation or update to the sales associate tracking module 160. For example, a sales associate could accept the request and the acceptance would be transmitted to the sales associate tracking module 160.

Then, at 232, the sales associate tracking module 160 determines whether the sales associate has fulfilled the request. The sales associate may indicate in the sales associate mobile device 120 that the request has been completed. The update may be transmitted to the sales associate tracking module 160. The sales associate tracking module 160 may also determine the fulfillment of the request by using the tracking sensor 124 and tracking when the sales associate goes into the fitting room. When it has been determined that the sales associate did not fulfill the request, the sales associate tracking module 160 may locate a new sales associate (step 222). For example, if the sales associate that was contacted hasn't sent a confirmation or update to the sales associate tracking module 160 and the tracking sensor does not indicate that the sales associate is moving, then it may be determined that the sales associate has not fulfilled the request.

Next, at 234, when it has been determined that the sales associate has fulfilled the request and when it has been determined that the answer was satisfactory, the merchandise tracking module 154 determines whether the customer is still in the fitting room. The merchandise tracking module 154 may determine whether the customer is still in the fitting room by tracking the merchandise using the merchandise tagging device 136. When the merchandise is still in the fitting room, the customer is still in the fitting room. When it has been determined that the customer is still in the fitting room, the merchandise tracking module 154 may continue to track the merchandise (step 204). When the merchandise is no longer in the fitting room it has been determined that the customer is no longer in the fitting room. For example, when the customer is finished they take the merchandise out of the fitting room signifying that they are done in the fitting room.

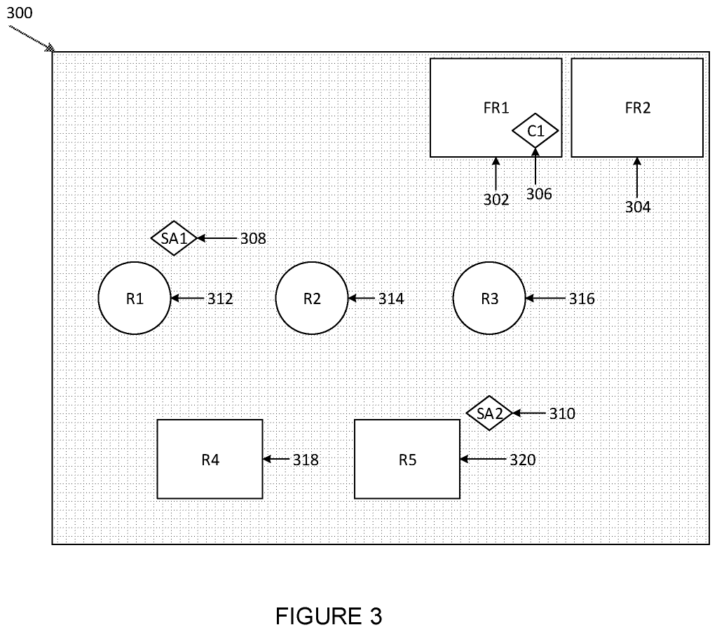

FIG. 3 illustrates an example of a retail store 300, where the present invention can be implemented. The retail store 300 may include a fitting room 1 (FR1) 302, a fitting room 2 (FR2) 304, a customer 1 (C1) 306, a sales associate 1 (SA1) 308, a sales associate 2 (SA2) 310, a rack 1 (R1) 312, a rack 2 (R2) 314, a rack 3 (R3) 316, a rack 4 (R4) 318, and a rack 5 (R5) 320. The following exemplary situation illustrates the disclosed invention being utilized. The customer 1 306 could be trying on merchandise in the fitting room 1 302. The instruction module 152 may provide instructions to the customer 1 306. The merchandise tracking module 154 may detect the merchandise that the customer 1 306 has brought into the fitting room. The customer 1 306 may ask the virtual assistant device 130 for a smaller size for the shirt they are trying on. The question analyzer module 156 may evaluate the nature of the question and the merchandise tracking module 154 may determine which article of merchandise the customer is referring to. The question analyzer module 156 may ask for confirmation from the customer 1 306 when multiple IoT sensors are read to ensure the context of the question. For example, if there is a shirt hanging on a hanger and a shirt on the customer 1 306, the system may ask the customer 1 306 to confirm that they would like a new size of the shirt that they are currently trying on. The question analyzer module 156 may determine that a sales associate needs to be contacted. The tacking sensor 124 in the sales associate mobile device 120 may transmit the location of the sales associate 1 308 and the sales associate 2 310 to the sales associate tracking module 160. The sales associate tracking module 160 may determine that the sales associate 1 308 should be contacted because the sales associate 1 308 is closer to the rack 1 312 where the shirts are located. The sales associate tracking module 160 may contact the sales associate 1 308 and may request the sales associate 1 308 bring a smaller size of the indicated shirt to the fitting room 1 302, where the customer is currently located. The customer 1 306 may receive the shirt and indicate satisfaction to the virtual assistant device 130. The customer 1 306 may then remove all of the merchandise from the fitting room 1 302 themselves or by giving it to another store associate to return.

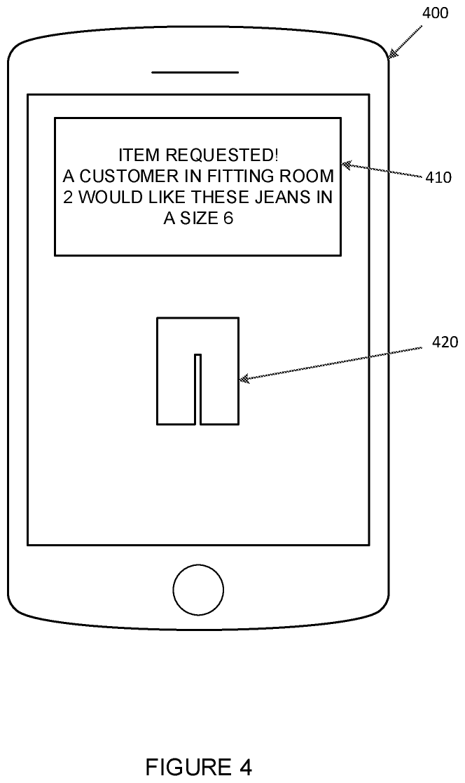

FIG. 4 illustrates an example of a sales associate mobile device 400, where the present invention can be implemented. The sales associate mobile device 400 may include a message 410 and a picture of an article of merchandise 420. The message 410 may be a message from the sales associate tracking module 160 that includes which article of merchandise a customer is asking for and where to bring the article of merchandise. For example, the message 410 may read “Item Requested! A customer in fitting room 2 would like these jeans in a size 6”. The picture of the article of merchandise 420 is the article of merchandise that the customer is asking for. For example, the customer is asking for a pair of jeans in a new size so the picture of the article of merchandise 420 would be the pair of jeans.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

FIG. 5 depicts a block diagram of components of the sales associate mobile device 120 and the virtual assistant device 130 of the system for a fitting room virtual assistant based on real-time IoT 100 of FIG. 1, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

The sales associate mobile device 120 and/or the virtual assistant device 130 and/or the server 140 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the virtual assistant application 150 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The sales associate mobile device 120 and/or the virtual assistant device 130 and/or the server 140 may also include a R/W drive or interface 914 to read from and write to one or more portable computer readable storage media 926. Application programs 911 on the sales associate mobile device 120 and/or the virtual assistant device 130 and/or the server 140 may be stored on one or more of the portable computer readable storage media 926, read via the respective R/W drive or interface 914 and loaded into the respective computer readable storage media 908.

The sales associate mobile device 120 and/or the virtual assistant device 130 and/or the server 140 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the sales associate mobile device 120 and/or the virtual assistant device 130 and/or the server 140 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The sales associate mobile device 120 and/or the virtual assistant device 130 and/or the server 140 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and fitting room virtual assistance 96. Fitting room virtual assistance 96 may allow real-time IoT to better engage customers in a retail store. Fitting room virtual assistance 96 may provide answers to questions about specific merchandise and contact sales associates to retrieve specific merchandise.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for a fitting room virtual assistant based on Internet of Things (IoT) sensors, the method comprising:
receiving, by a computer, a plurality of merchandise tracking data, wherein the plurality of merchandise tracking data shows a location of a plurality of merchandise in a fitting room;
receiving a question from a customer, wherein the customer asked a virtual assistant the question near the fitting room;
determining whether a sales associate should be contacted based on the nature of the question; and
performing an action based on the determination.

2. The method of claim 1, further comprising:
providing a plurality of instructions to the customer, wherein the plurality of instructions includes an introduction and a plurality of directions on how to use the virtual assistant.

3. The method of claim 1, wherein the action further comprises:
providing a response to the question based on a plurality of IoT sensors.

4. The method of claim 1, further comprising:
in response to being unable to determine an item within the plurality of merchandise to which the question relates, prompting the customer to confirm the item.

5. The method of claim 1, wherein performing the action further comprises:
in response to determining that the sales associate should be contacted, locating a sales associate within a preconfigured distance of a specific department based on a store location of an item within the plurality of merchandise the question is referring to; and
in response to determining that the sales associate should not be contacted, providing an answer to the question from a merchandise database, wherein the merchandise database includes information on the plurality of merchandise.

6. The method of claim 5, wherein the locating includes indicating where the sales associate can find the customer within the fitting room.

7. The method of claim 5, further comprising:
determining whether the provided answer was satisfactory based on a response from the customer; and
when it has been determined that the provided answer was not satisfactory, providing a new answer from the merchandise database.

8. The method of claim 5, further comprising:
determining whether the sales associate has fulfilled the request based on a plurality of location tracking data; and
when it has been determined that the sales associate has not fulfilled the request, locating a new sales associate to fulfill the request.

9. A computer program product for a fitting room virtual assistant based on IoT sensors, the computer program product comprising:
one or more non-transitory computer-readable storage media and program instructions stored on the one or more non-transitory computer-readable storage media capable of performing a method, the method comprising:
receiving, by a computer, a plurality of merchandise tracking data, wherein the plurality of merchandise tracking data shows a location of a plurality of merchandise in a fitting room;
receiving a question from a customer, wherein the customer asked a virtual assistant the question near the fitting room;
determining whether a sales associate should be contacted based on the nature of the question; and
performing an action based on the determination.

10. The computer program product of claim 9, further comprising:
providing a plurality of instructions to the customer, wherein the plurality of instructions includes an introduction and a plurality of directions on how to use the virtual assistant.

11. The computer program product of claim 9, wherein the action further comprises:
providing a response to the question based on a plurality of IoT sensors.

12. The computer program product of claim 9, further comprising:
in response to being unable to determine an item within the plurality of merchandise to which the question relates, prompting the customer to confirm the item.

13. The computer program product of claim 9, wherein performing the action further comprises:
in response to determining that the sales associate should be contacted, locating a sales associate within a preconfigured distance of a specific department based on a store location of an item within the plurality of merchandise the question is referring to; and
in response to determining that the sales associate should not be contacted, providing an answer to the question from a merchandise database, wherein the merchandise database includes information on the plurality of merchandise.

14. The computer program product of claim 13, wherein the locating includes indicating where the sales associate can find the customer within the fitting room.

15. The computer program product of claim 13, further comprising:
determining whether the provided answer was satisfactory based on a response from the customer; and
when it has been determined that the provided answer was not satisfactory, providing a new answer from the merchandise database.

16. The computer program product of claim 13, further comprising:
determining whether the sales associate has fulfilled the request based on a plurality of location tracking data; and
when it has been determined that the sales associate has not fulfilled the request, locating a new sales associate to fulfill the request.

17. A computer system for a fitting room virtual assistant based on IoT sensors, the computer system comprising:
one or more computer processors, one or more computer-readable storage media, and program instructions stored on one or more of the computer-readable storage media for execution by at least one of the one or more processors capable of performing a method, the method comprising:
receiving, by a computer, a plurality of merchandise tracking data, wherein the plurality of merchandise tracking data shows a location of a plurality of merchandise in a fitting room;
receiving a question from a customer, wherein the customer asked a virtual assistant the question near the fitting room;
determining whether a sales associate should be contacted based on the nature of the question; and
performing an action based on the determination.

18. The computer system of claim 17, wherein the action further comprises:
providing a response to the question based on a plurality of IoT sensors.

19. The computer system of claim 17, further comprising:
in response to being unable to determine an item within the plurality of merchandise to which the question relates, prompting the customer to confirm the item.

20. The computer system of claim 17, wherein performing the action further comprises:
in response to determining that the sales associate should be contacted, locating a sales associate within a preconfigured distance of a specific department based on a store location of an item within the plurality of merchandise the question is referring to; and
in response to determining that the sales associate should not be contacted, providing an answer to the question from a merchandise database, wherein the merchandise database includes information on the plurality of merchandise.
